(19) United States
(12) Patent Application Publication
(10) Pub. No.: US 2002/0097797 A1
(43) Pub. Date: Jul. 25, 2002

(54) Method and apparatus for decoding picture signal at variable picture rate

(76) Inventor: Kenji Sugiyama, Yokosuka-shi (JP)

Correspondence Address: LAW OFFICES OF LOUIS WOO, Suite 501, 1901 North Fort Myer Drive, Arlington, VA, 22209, US

(21) Appl. No.: 10/029,793

(22) Filed: Dec. 31, 2001

(30) Foreign Application Priority Data
Jan. 23, 2001 (JP) 2001-14251

(51) Int. Cl. H04B 1/66

(52) U.S. Cl. 375/240.01

(57) ABSTRACT

Information is gotten which indicates the number of pixels composing every frame represented by an input signal indicative of a sequence of pictures including bidirectionally predictive coded pictures. A desired decoding picture rate is set in response to a predetermined decoding capability and the pixel number. A part of the input signal which is indicative of at least one among the bidirectionally predictive coded pictures is discarded in response to the desired decoding picture rate, and hence a non-discarded part of the input signal is generated. The non-discarded part of the input signal is decoded into a first decoding-resultant signal at a decoding picture rate equal to the desired decoding picture rate. A decoding-resultant signal portion corresponding to the discarded part of the input signal is interpolated in response to the first decoding-resultant signal. The interpolated decoding-resultant signal portion and the first decoding-resultant signal are combined into a reproduced signal.

### BACKGROUND OF THE INVENTION

1. Field of the Invention

This invention relates to an apparatus for decoding a picture signal at a variable picture rate. In addition, this invention relates to a method of decoding a picture signal at a variable picture rate.

2. Description of the Related Art

According to moving picture coding, in some of the cases where coding is done at an especially low transfer bit rate such as 64 kbps, all incoming pictures are not coded and only decimated portion pictures are coded. In accordance therewith, the decoding sequentially decodes an incoming bit stream, and a decoded frame is repetitively outputted until a next frame is decoded.

On the other hand, even in the case where coding is at a prescribed picture rate, coding by a software procedure or the like does not decode all pictures and decodes only decimated portion pictures when a decoding processing capability is insufficient to completely decode an incoming bit stream in real-time. As a result, a decoding picture rate becomes variable.

Inter-picture (Inter-frame) predictive coding containing bidirectional prediction which is by an MPEG system generates pictures called P pictures and using inter-picture predictive coding in one direction, and pictures called B pictures and using inter-picture predicting coding in bidirections in addition to pictures called I pictures and being by independent coding (intra-picture coding).

Here, since the B pictures do not become reference frames for other frames, the other pictures would not be affected even if the B pictures are not decoded. Thereby, a bit stream of B pictures is deleted, and the decoding picture rate can be dropped. If the P pictures with which recursive prediction is done are not decoded, a next frame could not be decoded. Accordingly, the P pictures can not be deleted.

According to a prior-art variable picture rate decoding apparatus, in the case where a processing capability is insufficient to an incoming bit stream, the intervals between reproduced frames become irregular in response to a variation in frame code amount and optimal decoding processing can not be always done since at the moment of the completion of the decoding processing of a current frame, decoding of a next frame which can be decoded is performed.

In the case where a frame memory capacity for decoding processing is insufficient with respect to a frame pixel number (a frame size), decoding processing can not be done.

### SUMMARY OF THE INVENTION

It is a first object of this invention to provide an improved apparatus for decoding a picture signal at a variable picture rate.

It is a second object of this invention to provide an improved method of decoding a picture signal at a variable picture rate.

A first aspect of this invention provides a variable picture rate decoding apparatus for reproducing a moving picture from an incoming bit stream coded by inter-picture (inter-frame) predictive coding including bidirectional prediction. The apparatus is characterized by comprising picture rate setting means for getting information about a frame pixel number of the previously-mentioned incoming bit stream, and setting a decoding picture rate of a moving picture from a relation between the previously-mentioned frame pixel number and a decoding processing capability; decoding means for causing at least a portion of bidirectional inter-picture prediction pictures in the previously-mentioned incoming bit stream to be not decoded, and performing decoding of the previously-mentioned incoming bit stream at the previously-mentioned coding picture rate to get decoded pictures; and interpolating means for interpolating a picture of the previously-mentioned decoded pictures to get a reproduced picture at a prescribed picture rate.

A second aspect of this invention provides a variable picture rate decoding apparatus for reproducing a moving picture from an incoming bit stream coded by inter-picture predictive coding including bidirectional prediction. The apparatus is characterized by comprising decoding controlling means for getting information about a frame pixel number of the previously-mentioned incoming bit stream, and setting a decoding method not decoding all bidirectional inter-picture prediction pictures in the previously-mentioned incoming bit stream in cases where decoding of bidirectional inter-picture prediction pictures in the previously-mentioned incoming bit stream can not be done from a relation between the previously-mentioned frame pixel number and a capacity of a frame memory for decoding which will be mentioned later; decoding means for decoding the incoming bit stream in accordance with the previously-mentioned decoding method to get decoded pictures; and a frame memory for decoding which uses a memory corresponding to 4 frames when bidirectional prediction is done as a memory corresponding to two frames double in pixel number in cases where bidirectional prediction is not done in accordance with the previously-mentioned decoding method, and getting a prescribed reproduced picture from the previously mentioned decoded pictures.

A third aspect of this invention provides a variable picture rate decoding method of reproducing a moving picture from an incoming bit stream coded by inter-picture predictive coding including bidirectional prediction. The method is characterized by comprising the steps of getting information about a frame pixel number of the previously-mentioned incoming bit stream, and setting a decoding picture rate of a moving picture from a relation between the previously-mentioned frame pixel number and a decoding processing capability; causing at least a portion of bidirectional inter-picture prediction pictures in the previously-mentioned incoming bit stream to be not decoded, and performing decoding of the previously-mentioned incoming bit stream at the previously-mentioned set coding picture rate to get decoded pictures; and interpolating a picture of the previously-mentioned gotten decoded pictures to get a reproduced picture at a prescribed picture rate.

A fourth aspect of this invention provides a variable picture rate decoding method of reproducing a moving picture from an incoming bit stream coded by inter-picture predictive coding including bidirectional prediction. The method is characterized by comprising the steps of getting information about a frame pixel number of the previously-mentioned incoming bit stream, and setting a decoding method not decoding all bidirectional inter-picture prediction pictures in the previously-mentioned incoming bit stream in cases where decoding of bidirectional inter-picture prediction pictures in the previously-mentioned incoming bit stream can not be done from a relation between the previously-mentioned frame pixel number and a capacity of a frame memory for decoding which will be mentioned later; decoding the incoming bit stream in accordance with the previously-mentioned decoding method to get decoded pictures; and getting a prescribed reproduced picture from the previously-mentioned gotten decoded pictures by a frame memory for decoding which uses a memory corresponding to 4 frames when bidirectional prediction is done as a memory corresponding to two frames double in pixel number in cases where bidirectional prediction is not done in accordance with the previously-mentioned decoding method.

### BRIEF DESCRIPTION OF THE DRAWINGS

FIG. 1 is a block diagram of a prior-art apparatus for decoding a picture signal.

FIG. 2 is a block diagram of an apparatus for decoding a picture signal at a variable picture rate according to a first embodiment of this invention.

FIG. 3 is a diagram of an example of picture sequences generated by a decimating procedure.

FIG. 4 is a diagram of an example of picture sets generated by interpolation procedures.

FIG. 5 is a block diagram of an apparatus for decoding a picture signal at a variable picture rate according to a second embodiment of this invention.

FIG. 6 is a diagram of frame memories in FIG. 5.

### DETAILED DESCRIPTION OF THE INVENTION

A prior-art apparatus for decoding a picture signal will be explained below for a better understanding of this invention.

FIG. 1 shows a prior-art apparatus including a buffer 131 to which an input signal is fed via an input terminal 111. The input signal has a bit stream of a variable length code and representing a sequence of pictures including I pictures, P pictures, and B pictures. The input signal is temporarily stored in the buffer 131 before being fed from the buffer 131 to a variable length decoder 101 via a switch 132.

In general, the variable length code forming the input signal represents residuals (inter-frame prediction errors). The variable length decoder 101 converts the variable length code back to a fixed length code. The fixed length code is fed from the variable length decoder 101 to an inverse quantizer 102. The inverse quantizer 102 subjects the fixed length code to inverse quantization, thereby converting the fixed length code into data representing DCT (discrete cosine transform) coefficients corresponding to residuals (inter-frame prediction errors). The DCT-coefficient data are fed from the inverse quantizer 102 to an inverse DCT device 103. The inverse DCT device 103 processes the DCT-coefficient data block by block. Here, every block corresponds to 8 by 8 DCT coefficients. The inverse DCT device 103 subjects every block to inverse DCT, thereby reproducing a prediction error signal. The reproduced prediction error signal is fed from the inverse DCT device 103 to an adder 104. The adder 104 receives a prediction signal from an inter-frame predictor 109. The device 104 adds the reproduced prediction error signal and the prediction signal into a reproduced picture signal (a decoding-resultant signal). The prediction signal corresponding to an I picture is “0”.

The reproduced picture signal (the decoding-resultant signal) is outputted from the adder 104, being written into a frame memory 105. The reproduced picture signal representative of a reproduced picture corresponding to a B picture is fed from the frame memory 105 to a switch 106, being transmitted to an external via the switch 106 and an output terminal 107. The reproduced picture signal representative of a reproduced picture corresponding to a P picture or an I picture is transferred from the frame memory 105 into a frame memory 110. The reproduced P-picture signal (the reproduced I-picture signal) is temporarily stored in the frame memory 110 before being fed therefrom to the inter-frame predictor 109 and also the switch 106. Thus, the reproduced P-picture signal (the reproduced I-picture signal) is transmitted from the frame memory 105 to the switch 106 via the frame memory 110 while being delayed by the frame memory 110. The inter-frame predictor 109 uses the reproduced P-picture signal (the reproduced I-picture signal) as an indication of a reference picture.

The inter-frame predictor 109 generates the prediction signal from the reference picture signal. The inter-frame predictor 109 feeds the prediction signal to the adder 104. The switch 106 selects the reproduced B-picture signal fed from the frame memory 105 or the reproduced P-picture signal (the I-picture signal) fed from the frame memory 110, generating a second reproduced signal representing a sequence of original pictures in a normal order. The second reproduced signal is transmitted from the switch 106 to an external via the output terminal 107.

Decoding is possible even when the frame size of the incoming bit stream varies. In the case of a frame size greater than a prescribed decoding processing capability, decoding is not completed in a prescribed processing time corresponding to one frame. In this case, the rate of a bit stream read out from the buffer 131 becomes lower than the original. On the other hand, the rate of the incoming bit stream remains the original. Therefore, the bit stream overflows from the buffer 131. The overflow bit stream is discarded by the switch 132.

The discarded bit stream of a current frame remains not decoded, and the decoding processing shifts to a next frame. Since the code amount of each frame in the incoming bit stream varies greatly, it is uncertain what frame can be decoded. If a P picture or an I picture is not decoded, later frames up to a next I picture could not be decoded.

### First Embodiment

In a first embodiment of this invention, an optimal decoding picture rate is set on the basis of (1) the number of pixels composing one frame and (2) the decoding capability. In view of the relation of the picture rate with the intervals between P pictures, a decoding procedure is designed so that the P pictures will be reproduced. Even in the case where the reproduced-picture rate drops, the maximum decoding determined by the decoding capability is implemented and the intervals between reproduced pictures are constant.

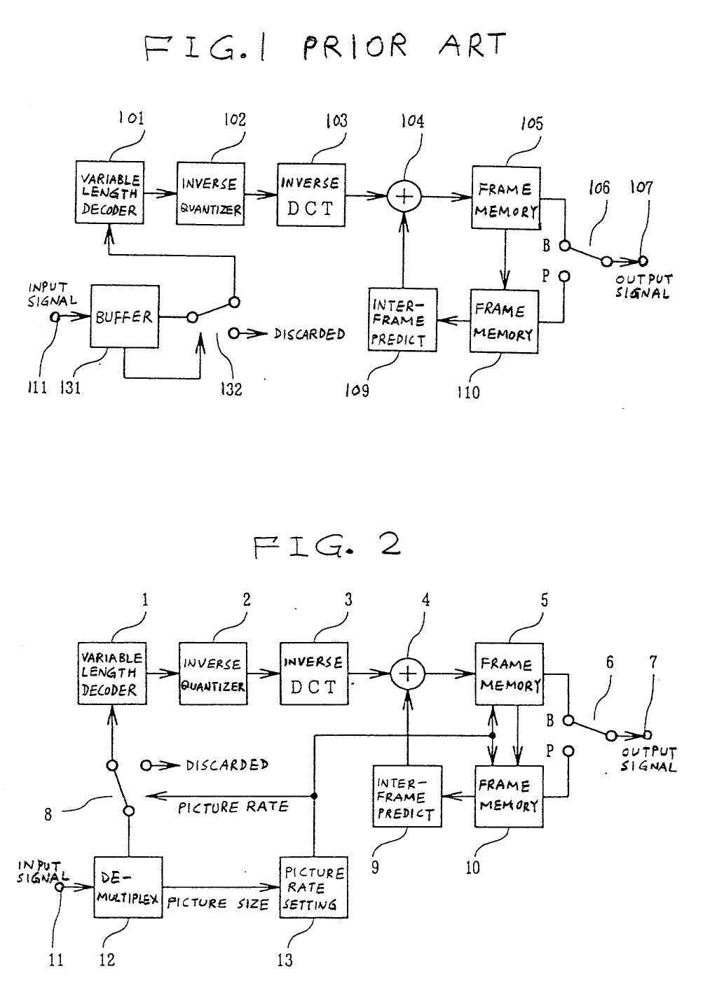

FIG. 2 shows an apparatus for decoding a picture signal at a variable picture rate according to the first embodiment of this invention. The apparatus of FIG. 2 includes a variable length decoder 1, an inverse quantizer 2, an inverse DCT (discrete cosine transform) device 3, an adder 4, a frame memory 5, a switch 6, an output terminal 7, a switch 8, an inter-frame predictor 9, a frame memory 10, an input terminal 11, a demultiplexer 12, and a picture rate setting device 13.

The variable length decoder 1, the inverse quantizer 2, and the inverse DCT device 3 are successively connected in that order. The adder 4 is connected to the inverse DCT device 3, the frame memory 5, and the inter-frame predictor 9. The frame memory 5 is connected to the switch 6, the frame memory 10, and the picture rate setting device 13. The switch 6 is connected to the output terminal 7 and the frame memory 10. The switch 8 is connected to the variable length decoder 1, the demultiplexer 12, and the picture rate setting device 13. The inter-frame predictor 9 is connected to the frame memory 10. The frame memory 10 is connected to the picture rate setting device 13. The input terminal 11 is connected to the demultiplexer 12. The demultiplexer 12 is connected to the picture rate setting device 13.

An input signal travels to the demultiplexer 12 via the input terminal 11. The input signal has a bit stream generated by an MPEG coding procedure. The bit stream is of a variable length code, and represents a sequence of progressively-scanned pictures including I pictures, P pictures, and B pictures. The I pictures mean intra coded pictures. The P pictures mean predictive coded pictures (unidirectionally predictive coded pictures). The B pictures mean bidirectionally predictive coded pictures. The MPEG coding procedure is designed so that the intervals between P pictures (or the intervals between P pictures and I pictures) correspond to 6 frames. The size of every picture (frame) represented by the input signal, that is, the number of pixels composing every picture, can be changed among first, second, and third values referred to as “480 p”, “720 p”, and “1080 p” respectively.

For one 480 p picture, a luminance signal represents 720 by 480pixels. For one 720 p picture, a luminance signal represents 1280 by 720 pixels. Alternatively, a luminance signal may represent 960 by 720 pixels. For one 1080 p picture, a luminance signal represents 1920 by 1080 pixels. Regardless of picture size, the input signal has a picture rate of 60 fps (frame per second). The input signal results from multiplexing picture-representing data and picture-size-related information. The picture-size-related information is designed for identifying the picture size used by the picture-representing data.

The demultiplexer 12 separates the input signal into the picture-representing data and the picture-size-related information. Thus, the demultiplexer 12 extracts the picture-size-related information from the input signal. The picture-representing data are of the variable length code. Usually, the variable length code represents residuals (inter-frame prediction errors). The variable-length code is fed from the demultiplexer 12 to the variable length decoder 1 via the switch 8. The picture-size-related information is fed from the demultiplexer 12 to the picture rate setting device 13.

The picture rate setting device 13 includes a memory such as a ROM which stores information representing a preset value of the decoding capability of the apparatus in FIG. 2. The picture rate setting device 13 determines a desired decoding picture rate in response to the decoding capability value and the picture size represented by the picture-size-related information. For example, the picture rate setting device 13 includes a ROM storing data representing a table (or a map) which provides a preset relation of the desired decoding picture rate with the decoding capability value and the picture size. The determination of the desired decoding picture rate is executed by referring to the table in response to the decoding capability value and the picture size. The picture rate setting device 13 generates a signal representing the determined desired decoding picture rate. The picture rate setting device 13 feeds the picture-rate signal to the switch 8. In addition, the picture rate setting device 13 feeds the picture-rate signal to the frame memories 5 and 10.

A required decoding capability is proportional to the product of the picture size and the picture rate. A picture size of 720 p is equal to a picture size of 480 p which is multiplied by 2.67. A picture size of 1080 p is equal to a picture size of 480 p which is multiplied by 6. Thus, in the case of a decoding capability corresponding to a picture size of 480 p and a picture rate of 60 fps, data representing a sequence of 720 p pictures can be processed at a picture rate of about 22.5 fps. Data representing a sequence of 1080 p pictures can be processed at a picture rate of 10 fps. As the decoding capability rises, the picture decoding rate can increase. Specifically, in the case of a decoding capability corresponding to twice a picture size of 480 p and a picture rate of 60 fps, data representing a sequence of 720 p pictures can be processed at a picture rate of about 45 fps. Data representing a sequence of 1080 p pictures can be processed at a picture rate of 20 fps. In the case of a decoding capability corresponding to three times a picture size of 480 p and a picture rate of 60 fps, data representing a sequence of 720 p pictures can be processed at a picture rate of 60 fps. Data representing a sequence of 1080 p pictures can be processed at a picture rate of 30 fps. In the case of a decoding capability corresponding to six times a picture size of 480 p and a picture rate of 60 fps, data representing a sequence of 720 p pictures can be processed at a picture rate of 60 fps. Also, data representing a sequence of 1080 p pictures can be processed at a picture rate of 60 fps.

In fact, a decoding process for data representing a B picture differs from that for data representing a P picture. In general, the amount of work of processing B-picture data is greater than that of work of processing P-picture data. Since decoding picture-header data is independent of the picture size, the amount of work of processing one-picture data is not simply proportional to the number of pixels composing one frame (one picture). These decoding characteristics are decided by a decoding algorithm and also a decoding and processing circuit. Preferably, the picture rate setting device 13 is designed in view of the decoding characteristics.

For example, the desired picture rate given by the picture rate setting device 13 is designed as follows. In the case of a decoding capability corresponding to a picture size of 480 p and a picture rate of 60 fps, the desired picture rate is equal to 20 fps for data representing a sequence of 720 p pictures. The desired picture rate is equal to 10 fps for data representing a sequence of 1080 p pictures. In the case of a decoding capability corresponding to twice a picture size of 480 p and a picture rate of 60 fps, the desired picture rate is equal to 30 fps for data representing a sequence of 720 p pictures. The desired picture rate is equal to 20 fps for data representing a sequence of 1080 p pictures. In the case of a decoding capability corresponding to three times a picture size of 480 p and a picture rate of 60 fps, the desired picture rate is equal to 60 fps for data representing a sequence of 720 p pictures. The desired picture rate is equal to 30 fps for data representing a sequence of 1080 p pictures. In the case of a decoding capability corresponding to six times a picture size of 480 p and a picture rate of 60 fps, the desired picture rate is equal to 60 fps for data representing a sequence of 720 p. The desired picture rate is also equal to 60 fps for data representing a sequence of 1080 p pictures.

The switch 8 is responsive to the picture-rate signal fed from the picture rate setting device 13. The picture-representing data outputted from the demultiplexer 12 to the switch 8 have a picture rate always equal to 60 fps. When the desired picture rate represented by the picture-rate signal fed from the picture rate setting device 13 is smaller than 60 fps, the switch 8 periodically discards the picture-representing data and transmits only non-discarded portions of the picture-representing data to the variable length decoder 1. Thus, in this case, the switch 8 decimates the picture-representing data into second picture-representing data having a picture rate smaller than 60 fps and equal to the desired picture rate. The switch 8 transmits the second picture-representing data to the variable length decoder 1. In this way, the switch 8 separates portions of the picture-representing data into discarded ones and non-discarded ones. Portions of the picture-representing data which represent B pictures can be selected as discarded ones. On the other hand, portions of the picture-representing data which represent I pictures and P pictures are selected as non-discarded ones. To this end, the switch 8 implements separation of portions of the picture-representing data into discarded ones and non-discarded ones in response to the types of the pictures represented by the picture-representing data portions.

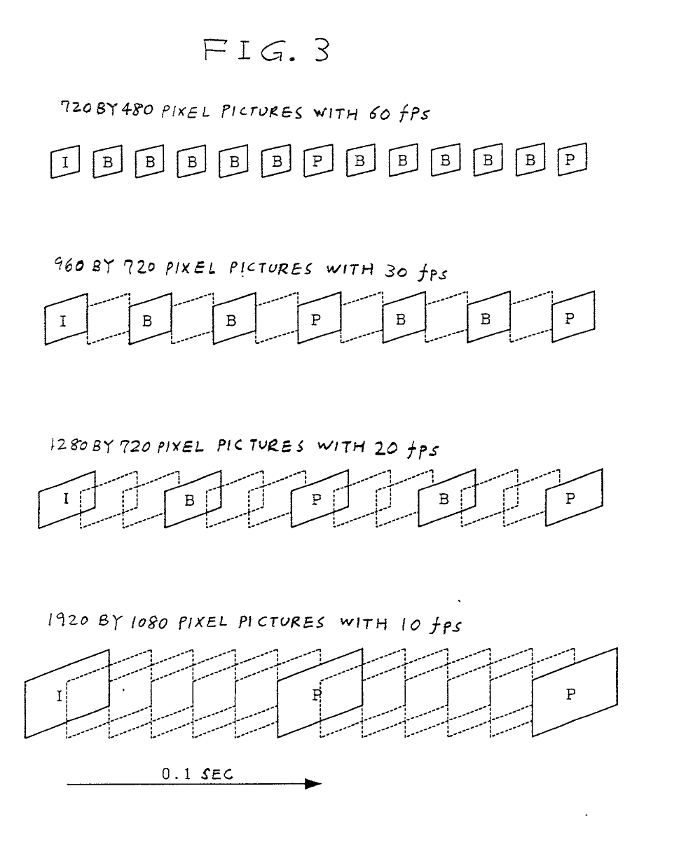

FIG. 3 shows an example of a picture sequence of “I, B, B, B, B, B, P, B, B, B, B, B, and P” which is represented by the picture-representing data outputted from the demultiplexer 12 to the switch 8. Here, “I” denotes an I picture while “B” and “P” denote a B picture and a P picture respectively. When the decoding capability corresponds to a picture size of 480 p (720 by 480 pixels) and a picture rate of 60 fps, the switch 8 operates as follows. With reference to FIG. 3, in the case where the picture-representing data outputted from the demultiplexer 12 relate to a picture size of 720 by 480 pixels and a picture rate of 60 fps, the switch 8 transmits the whole of the picture-representing data to the variable length decoder 1. In the case where the picture-representing data relate to a picture size of 960 by 720 pixels and a picture rate of 60 fps, the switch 8 periodically discards the picture-representing data and transmits only non-discarded portions of the picture-representing data to the variable length decoder 1. In this case, the picture sequence of “I, B, B, B, B, B, P, B, B, B, B, B, and P” is decimated into a picture sequence of “I, B, B, P, B, B, and P”. Thus, portions of the picture-representing data which represent alternate ones of B pictures are discarded. The non-discarded portions of the picture-representing data relate to a picture rate of 30 fps which is equal to the desired picture rate. In the case where the picture-representing data relate to a picture size of 1280 by 720 pixels and a picture rate of 60 fps, the switch 8 periodically discards the picture-representing data and transmits only non-discarded portions of the picture-representing data to the variable length decoder 1. In this case, the picture sequence of “I, B, B, B, B, B, P, 1 0 B, B, B, B, B, and P” is decimated into a picture sequence of “I, B, P, B, and P”. Thus, among portions of the picture-representing data which represent B pictures, only ones corresponding to every five B pictures are non-discarded. The non-discarded portions of the picture-representing data relate to a picture rate of 20 fps which is equal to the desired picture rate. In the case where the picture-representing data relate to a picture size of 1920 by 1080 pixels and a picture rate of 60 fps, the switch 8 periodically discards the picture-representing data and transmits only non-discarded portions of the picture-representing data to the variable length decoder 1. In this case, the picture sequence of “I, B, B, B, B, B, P, B, B, B, B, B, and P” is decimated into a picture sequence of “I, P, and P”. Thus, all portions of the picture-representing data which represent B pictures are discarded. The non-discarded portions of the picture-representing data relate to a picture rate of 10 fps which is equal to the desired picture rate.

The switch 8 includes a picture-header detector which extracts picture-header information from the picture-representing data outputted by the demultiplexer 12. The switch 8 also includes a first deciding section for recognizing which of an I picture, a P picture, and a B picture every picture represented by the picture-representing data agrees with on the basis of the extracted picture-header information. The switch 8 further includes a second deciding section for recognizing a frame order number assigned to every picture represented by the picture-representing data on the basis of the extracted picture-header information. In addition, the switch 8 includes a switching section for, when the desired picture rate is smaller than 60 fps, periodically discarding B-picture-corresponding portions of the picture-representing data on the basis of the recognized picture type and the recognized frame order number. The switch 8 transmits non-discarded portions of the picture-representing data to the variable length decoder 1. The non-discarded portions of the picture-representing data relate to picture rate smaller than 60 fps and equal to the desired picture rate.

The variable length code forming the picture-representing data outputted from the switch 8 to the variable length decoder 1 represents prediction errors. The variable length decoder 1 converts the variable length code back to a fixed length code. The fixed length code is fed from the variable length decoder 1 to the inverse quantizer 2. The inverse quantizer 2 subjects the fixed length code to inverse quantization, thereby converting the fixed length code into data representing DCT (discrete cosine transform) coefficients corresponding to residuals (inter-frame prediction errors). The DCT-coefficient data are fed from the inverse quantizer 2 to the inverse DCT device 3. The inverse DCT device 3 processes the DCT-coefficient data block by block. Here, every block corresponds to 8 by 8 DCT coefficients. The inverse DCT device 3 subjects every block to inverse DCT, thereby reproducing a prediction error signal. The reproduced prediction error signal is fed from the inverse DCT device 3 to the adder 4. The adder 4 receives a prediction signal from the inter-frame predictor 9. The device 4 adds the reproduced prediction error signal and the prediction signal into a reproduced picture signal (a decoding-resultant signal). The prediction signal corresponding to an I picture is “0”.

The reproduced picture signal (the decoding-resultant signal) is outputted from the adder 4, being written into the frame memory 5. The reproduced picture signal representative of a reproduced picture corresponding to a B picture is fed from the frame memory 5 to the switch 6, being transmitted to an external via the switch 6 and the output terminal 7. The reproduced picture signal representative of a reproduced picture corresponding to a P picture or an I picture is transferred from the frame memory 5 into the frame memory 10. The reproduced P-picture signal (the reproduced I-picture signal) is temporarily stored in the frame memory 10 before being fed therefrom to the inter-frame predictor 9 and also the switch 6. Thus, the reproduced P-picture signal (the reproduced I-picture signal) is transmitted from the frame memory 5 to the switch 6 via the frame memory 10 while being delayed by the frame memory 10. The inter-frame predictor 9 uses the reproduced P-picture signal (the reproduced I-picture signal) as an indication of a reference picture. The inter-frame predictor 9 generates the prediction signal from the reference picture signal. The frame memory 10 can store two picture signals as indications of a forward prediction reference picture and a backward prediction reference picture. The inter-frame predictor 9 generates the prediction signal on the basis of at least one of the two picture signals in the frame memory 10. The inter-frame predictor 9 feeds the prediction signal to the adder 4. The switch 6 selects the reproduced B-picture signal fed from the frame memory 5 or the reproduced P-picture signal (the reproduced I-picture signal) fed from the frame memory 10, generating a second reproduced signal representing a sequence of original pictures in a normal order. The second reproduced signal is transmitted from the switch 6 to an external via the output terminal 7. The reproduced B-picture signal, the reproduced P-picture signal, and the reproduced I-picture signal are also referred to as the decoding-resultant B-picture signal, the decoding-resultant P-picture signal, and the decoding-resultant I-picture signal respectively.

The frame memory 5 and 10 are responsive to the picture-rate signal fed from the picture rate setting device 13. In the case where portions of the picture-representing data are discarded by the switch 8, that is, in the case where the desired picture rate represented by the picture-rate signal is smaller than 60 fps, the frame memory 5 or 10 repetitively outputs the same picture signal to the switch 6 a given number of times to implement interpolation for frames corresponding to the discarded portions of the picture-representing data. As a result, the second reproduced signal generated by the switch 6 has a picture rate of 60 fps.

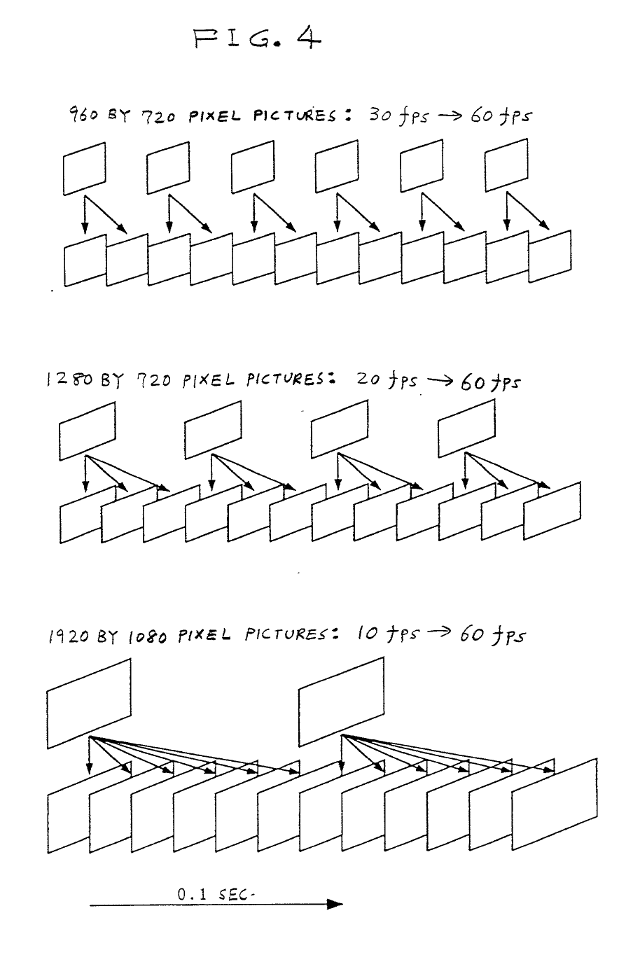

With reference to FIG. 4, in the case where the picture-representing data outputted from the switch 8 to the variable length decoder 1 have a picture rate of 30 fps and correspond to a picture size of 960 by 720 pixels, the frame memory 5 or 10 repetitively outputs the same picture signal to the switch 6 for two successive frames. In the case where the picture-representing data outputted from the switch 8 to the variable length decoder 1 have a picture rate of 20 fps and correspond to a picture size of 1280 by 720 pixels, the frame memory 5 or 10 repetitively outputs the same picture signal to the switch 6 for three successive frames. In the case where the picture-representing data outputted from the switch 8 to the variable length decoder 1 have a picture rate of 10 fps and correspond to a picture size of 1920 by 1080 pixels, the frame memory 5 or 10 repetitively outputs the same picture signal to the switch 6 for six successive frames.

The input signal applied to the demultiplexer 12 via the input terminal 11 may have a frame rate different from 60 fps. The input signal may be of the interlaced scanning format rather than the progressive scanning format. The intervals between P pictures (the intervals between P pictures and I pictures) may differ from 6 frames. The switch 8 may discard picture-representing data portions representative of pictures (including non-B pictures) which will not be used as reference pictures.

The first embodiment of this invention provides the advantage as follows. In the first embodiment of this invention, an optimal decoding picture rate is set on the basis of (1) the number of pixels composing one frame and (2) the decoding capability. In view of the relation of the picture rate with the intervals between P pictures, the P pictures can always be reproduced. Even in the case where the reproduced-picture rate drops, the maximum decoding determined by the decoding capability is implemented and the intervals between reproduced pictures are constant. Accordingly, even when the number of pixels composing one frame represented by the input signal varies, optimal reproduced pictures can be provided.

### Second Embodiment

According to a second embodiment of this invention, in the case where the number of pixels composing one frame and the capacity of frame memories are in ranges making it difficult to decode B-picture data, the frame memories are used in a featuring way so that only picture data except the B-picture data will be decoded. In this case, the frame memories having a capacity corresponding to four frames measured in the normal frame size can be used as those having a capacity corresponding to two frames measured in twice the normal frame size. Therefore, it is possible to reproduce a picture composed of pixels whose number is equal to at most twice the number of pixels composing a normal-sized picture.

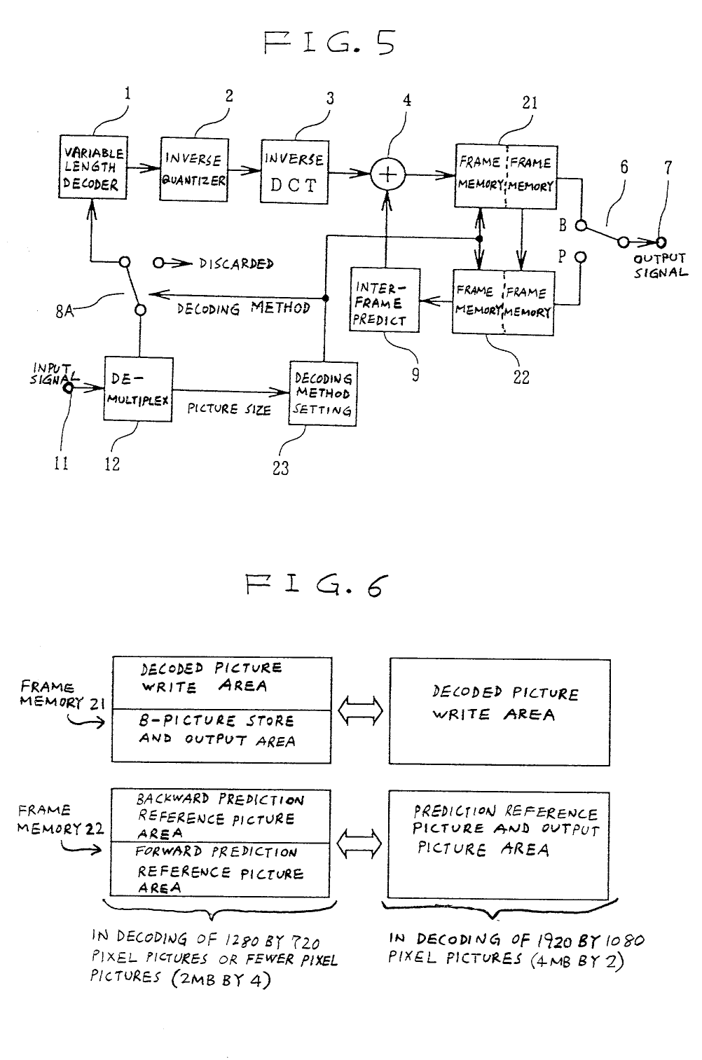

FIG. 5 shows an apparatus for decoding a picture signal at a variable picture rate according to the second embodiment of this invention. The apparatus of FIG. 5 is similar to the apparatus of FIG. 2 except for design changes mentioned hereafter. The apparatus of FIG. 5 includes a switch 8A instead of the switch 8 (see FIG. 2). The apparatus of FIG. 5 includes frame memories 21 and 22 instead of the frame memories 5 and 10 (see FIG. 2) respectively. The apparatus of FIG. 5 includes a decoding-method setting device 23 instead of the picture rate setting device 13 (see FIG. 2).

Preferably, the switch 8A is a modification of the switch 8 (see FIG. 2). Preferably, the frame memories 21 and 22 are modifications of the frame memories 5 and 10 (see FIG. 2) respectively. Preferably, the decoding-method setting device 23 is a modification of the picture rate setting device 13 (see FIG. 2).

The frame memories 21 and 22 can be used in a way different from that of using the frame memories 5 and 10 in the apparatus of FIG. 2. Operation of the apparatus of FIG. 5 can be set in a special mode where B-picture data will not be decoded. In the special mode of operation, used areas in the frame memories 21 and 22 are designed for reproduction of P pictures (or I pictures) each composed of pixels whose number is equal to at most twice the number of pixels composing a normal-sized picture. The frame memories 21 and 22 have a preset capacity.

The decoding-method setting device 23 receives the picture-size-related information from the demultiplexer 12. The decoding-method setting device 23 includes a memory such as a ROM which stores information representing the preset capacity of the frame memories 21 and 22. The decoding-method setting device 23 determines a desired decoding method in response to the picture size represented by the picture-size-related information and the preset capacity of the frame memories 21 and 22. For example, the decoding-method setting device 23 includes a ROM storing data representing a table (or a map) which provides a preset relation of the desired decoding method with the picture size and the frame-memory capacity. The determination of the desired decoding method is executed by referring to the table in response to the picture size and the frame-memory capacity. The desired decoding method indicates whether or not only P-picture data and I-picture data should be decoded, that is, whether or not B-picture data should be discarded without being decoded. The decoding-method setting device 23 generates a signal representing the determined desired decoding method. The decoding-method setting device 23 feeds the decoding-method signal to the switch 8A. In addition, the decoding-method setting device 23 feeds the decoding-method signal to the frame memories 21 and 22. The decoding-method signal indicates whether or not only P-picture data and I-picture data should be decoded, that is, whether or not B-picture data should be discarded without being decoded.

For example, the decoding-method setting device 23 decides whether or not the picture size represented by the picture-size-related information exceeds a prescribed reference value determined by the preset capacity of the frame memories 21 and 22. When the picture size exceeds the prescribed reference value, the decoding-method setting device 23 generates a decoding-method signal which indicates that only P-picture data and I-picture data should be decoded. On the other hand, when the picture size does not exceed the prescribed reference value, the decoding-method setting device 23 generates a decoding-method signal which indicates that B-picture data, P-picture data, and I-picture data should be decoded.

The switch 8A controls the transmission of the picture-representing data from the demultiplexer 12 to the variable length decoder 1 in response to the decoding-method signal. The switch 8A includes a picture-header detector which extracts picture-header information from the picture-representing data. The switch 8A also includes a deciding section for recognizing which of an I picture, a P picture, and a B picture every picture represented by the picture-representing data agrees with on the basis of the extracted picture-header information. The switch 8A further includes a switching section for, when the decoding-method signal indicates that only P-picture data and I-picture data should be decoded, discarding every B-picture-corresponding portion of the picture-representing data on the basis of the recognized picture type and the recognized frame order number. The switching section transmits non-discarded portions of the picture-representing data to the variable length decoder 1. The transmitted non-discarded portions of the picture-representing data represent only P pictures and I pictures. On the other hand, when the decoding-method signal indicates that B-picture data, P-picture data, and I-picture data should be decoded, the switching section transmits the whole of the picture-representing data to the variable length decoder 1. The transmitted data represent B pictures, P pictures, and I pictures.

There are first, second, third, and fourth frame memories or memory areas for decoding B-picture data. The first frame memory or the first memory area stores decoding-resultant picture data. The second frame memory or the second memory area stores decoding-resultant P-picture data (or decoding-resultant I-picture data) representing a forward prediction reference picture. The third frame memory or the third memory area stores decoding-resultant P-picture data (or decoding-resultant I-picture data) representing a backward prediction reference picture. The forward prediction reference picture and the backward prediction reference picture are used in bidirectional prediction for recovering a B picture. The fourth frame memory or the fourth memory area is used in repetitively outputting decoding-resultant B-picture data. In the absence of frame interpolation, the fourth frame memory or the fourth memory area can be omitted. The fourth frame memory or the fourth memory area may be used in the conversion of the scanning format from the progressive type to the interlaced type or the 2-3 pulldown processing of film pictures.

There are first and second frame memories or memory areas for decoding P-picture data or I-picture data. The first frame memory or the first memory area stores decoding-resultant picture data. The second frame memory or the second memory area is used for implementing inter-frame prediction and repetitively outputting the decoding-resultant picture data.

Accordingly, a memory size corresponding to four frames is used for decoding data representing every B picture while a memory size corresponding to two frames is used for decoding data representing every P picture or every I picture.

In general, the required capacity of a frame memory is proportional to the picture size related to the input signal. A picture size of 720 p is equal to a picture size of 480 p which is multiplied by 2.67. A picture size of 1080 p is equal to a picture size of 480 p which is multiplied by 6. Thus, in the case of a frame memory capacity corresponding to two 720 p frames (two 720 p pictures), 480 p-picture data representing I pictures, P-pictures, and B-pictures can be fully decoded. Only 720 p-picture data representing I pictures and P-pictures can be decoded. In the case of a frame memory capacity corresponding to two 1080 p frames (two 1080 p pictures), 480 p-picture data representing I pictures, P-pictures, and B-pictures can be fully decoded. Also, 720 p-picture data representing I pictures, P-pictures, and B-pictures can be fully decoded. Only 1080 p-picture data representing I pictures and P-pictures can be decoded.

The frame memories 21 and 22 have capacities equal to each other. The sum of the capacities of the frame memories 21 and 22 corresponds to, for example, two 1080 p frames (two 1080 p pictures). The frame memories 21 and 22 are responsive to the decoding-method signal fed from the decoding-method setting device 23.

With reference to FIG. 6, in the case where the decoding-method signal indicates that B-picture data, P-picture data, and I-picture data should be decoded, decoding-resultant picture data are written into a first half of the frame memory 21 from the adder 4 while decoding-resultant B-picture data are transferred to and stored in a second half of the frame memory 21 and are outputted therefrom to the switch 6. In this case, decoding-resultant P-picture data (or decoding-resultant I-picture data) representing a forward prediction reference picture are stored into a first half of the frame memory 22 from the frame memory 21, and are outputted from the frame memory 22 to the inter-frame predictor 9 and the switch 6. On the other hand, decoding-resultant P-picture data (or decoding-resultant I-picture data) representing a backward prediction reference picture are stored in a second half of the frame memory 22 from the frame memory 21, and are outputted from the frame memory 22 to the inter-frame predictor 9 and the switch 6.

In the case where the decoding-method signal indicates that only P-picture data and I-picture data should be decoded, decoding-resultant picture data are written into the frame memory 21 from the adder 4 while decoding-resultant P-picture data (or decoding-resultant I-picture data) representing a prediction reference picture are transferred from the frame memory 21 to the frame memory 22 and are then outputted from the frame memory 22 to the inter-2 frame predictor 9 and the switch 6. In this case, the whole area of the frame memory 21 is used to store decoding-resultant picture data, and also the whole area of the frame memory 22 is used to store reference-picture data. Therefore, it is possible to handle picture data relating to a picture size equal to twice the normal picture size (for example, 720 p).

The second embodiment of this invention provides the advantage as follows. According to the second embodiment of this invention, in the case where the number of pixels composing one frame and the capacity of the frame memories 21 and 22 are in ranges making it difficult to decode B-picture data, the frame memories 21 and 22 are used in a featuring way so that only picture data except the B-picture data will be decoded. In this case, the frame memories 21 and 22 having a capacity corresponding to four frames measured in the normal frame size can be used as those having a capacity corresponding to two frames measured in twice the normal frame size. Therefore, it is possible to reproduce a picture composed of pixels whose number is equal to at most twice the number of pixels composing a normal-sized picture. Accordingly, even when the number of pixels composing one frame represented by the input signal varies, optimal reproduced pictures can be provided.

What is claimed is:

1. A variable picture rate decoding apparatus for reproducing a moving picture from an incoming bit stream coded by inter-picture predictive coding including bidirectional prediction, characterized by comprising:
picture rate setting means for getting information about a frame pixel number of the previously-mentioned incoming bit stream, and setting a decoding picture rate of a moving picture from a relation between the previously-mentioned frame pixel number and a decoding processing capability;
decoding means for causing at least a portion of bidirectional inter-picture prediction pictures in the previously-mentioned incoming bit stream to be not decoded, and performing decoding of the previously-mentioned incoming bit stream at the previously-mentioned coding picture rate to get decoded pictures; and
interpolating means for interpolating a picture of the previously-mentioned decoded pictures to get a reproduced picture at a prescribed picture rate.

2. A variable picture rate decoding apparatus for reproducing a moving picture from an incoming bit stream coded by inter-picture predictive coding including bidirectional prediction, characterized by comprising:
decoding controlling means for getting information about a frame pixel number of the previously-mentioned incoming bit stream, and setting a decoding method not decoding all bidirectional inter-picture prediction pictures in the previously-mentioned incoming bit stream in cases where decoding of bidirectional inter-picture prediction pictures in the previously-mentioned incoming bit stream can not be done from a relation between the previously-mentioned frame pixel number and a capacity of a frame memory for decoding which will be mentioned later;
decoding means for decoding the incoming bit stream in accordance with the previously-mentioned decoding method to get decoded pictures; and
a frame memory for decoding which uses a memory corresponding to 4 frames when bidirectional prediction is done as a memory corresponding to two frames double in pixel number in cases where bidirectional prediction is not done in accordance with the previously-mentioned decoding method, and getting a prescribed reproduced picture from the previously-mentioned decoded pictures.

3. A variable picture rate decoding method of reproducing a moving picture from an incoming bit stream coded by inter-picture predictive coding including bidirectional prediction, characterized by comprising the steps of:
getting information about a frame pixel number of the previously-mentioned incoming bit stream, and setting a decoding picture rate of a moving picture from a relation between the previously-mentioned frame pixel number and a decoding processing capability;
causing at least a portion of bidirectional inter-picture prediction pictures in the previously-mentioned incoming bit stream to be not decoded, and performing decoding of the previously-mentioned incoming bit stream at the previously-mentioned set coding picture rate to get decoded pictures; and
interpolating a picture of the previously-mentioned gotten decoded pictures to get a reproduced picture at a prescribed picture rate.

4. A variable picture rate decoding method of reproducing a moving picture from an incoming bit stream coded by inter-picture predictive coding including bidirectional prediction, characterized by comprising the steps of:
getting information about a frame pixel number of the previously-mentioned incoming bit stream, and setting a decoding method not decoding all bidirectional inter-picture prediction pictures in the previously-mentioned incoming bit stream in cases where decoding of bidirectional inter-picture prediction pictures in the previously-mentioned incoming bit stream can not be done from a relation between the previously-mentioned frame pixel number and a capacity of a frame memory for decoding which will be mentioned later;
decoding the incoming bit stream in accordance with the previously-mentioned decoding method to get decoded pictures; and
getting a prescribed reproduced picture from the previously-mentioned gotten decoded pictures by a frame memory for decoding which uses a memory corresponding to 4 frames when bidirectional prediction is done as a memory corresponding to two frames double in pixel number in cases where bidirectional prediction is not done in accordance with the previously-mentioned decoding method.
